(19) United States
(12) Patent Application Publication
(10) Pub. No.: US 2025/0038429 A1
(43) Pub. Date: Jan. 30, 2025

(54) METHOD FOR MANUFACTURE OF AN ELECTRICAL OR ELECTRONIC COMPONENT PART BY INSERTION OF AN ELECTRICAL OR ELECTRONIC COMPONENT ELEMENT HAVING A METAL SHEATH SURROUNDING IT

(71) Applicant: Jacob Waitz Industrie GmbH, Kassel (DE)

(72) Inventor: Carsten BAUMGARTNER, Laubach (DE)

(21) Appl. No.: 18/781,661

(22) Filed: Jul. 23, 2024

(30) Foreign Application Priority Data
Jul. 25, 2023 (DE) 102023119673.1

(51) Int. Cl. H01R 4/20; B21D 39/04

(52) U.S. Cl. CPC H01R 4/20; B21D 39/048

(57) ABSTRACT

A method is provided for equipping a component element with a sheath. A plastically deformable metal sheath blank has a large size relative to the component and an elastically deformable auxiliary sleeve has a large size relative to the sheath blank. The component, sheath blank, and auxiliary sleeve are introduced into a radial press having press jaws moved radially in the direction of a press axis. A pressing tool of the radial press is closed with successively occurring bearing of the press jaws on the auxiliary sleeve, elastic radial contraction of the auxiliary sleeve until it bears on the sheath blank and plastic radial contraction of the sheath blank until it bears on the component element. Upon opening the pressing tool, the elastically deformable auxiliary sleeve lifts away from the sheath produced from the sheath blank and the finished component part can be removed from the auxiliary sleeve.

### CROSS REFERENCE TO RELATED APPLICATIONS

This application claims priority to German Application No. 10 2023 119 673.1, filed Jul. 25, 2023, the contents of which are incorporated by reference herein.

### FIELD OF THE INVENTION

The present invention relates to a method for manufacture of an electrical or electronic component part. In particular, the present invention relates to such a method in which—during the manufacture of the electrical or electronic component part in question—an electrical or electronic component element is equipped with a metal sheath surrounding it. In even further detail, the present invention relates to a method for equipping an electrical or electronic component element that is cylindrical at least in portions with a metal sheath surrounding it in close-fitting manner.

### BACKGROUND

In various electrical or electronic component elements, which—especially for their mechanical protection—are surrounded during use by a metal sheath, well-defined mechanical contact between the electrical or electronic component element and the metal sheath surrounding it is functionally decisive. This is the case in particular for applications in which good heat transfer ability exists between the electrical or electronic component element and the sheath surrounding it, for example because the electrical or electronic component element is a temperature sensor or a heating element. In precisely those applications, however, very good shape and dimensional stability of the outer surface of the electrical or electronic component element, i.e. of the metal sheath surrounding the electrical or electronic component element, is simultaneously of great importance, since typically such component parts are inserted for use into a respective bore of a device part, wherein these same strict requirements (see above) are applicable for the heat transfer ability between the sheath of the electrical or electronic component element and the device part in which this is received.

DE 101 56 299 A1 discloses a connection arrangement and a method for connecting a terminal element with an electrical conductor. For this purpose, the insulating sheath of an electrical cable having a conductor surrounded by an insulating sheath is stripped at the end and the corresponding end of the conductor is guided into the through bore of a hollow cylindrical terminal element. This is then pressed by radial deformation on the one hand onto the conductor and on the other hand—in its region protruding beyond the end of the conductor—deformed by reduction of its cross section to form a plug pin.

DE 103 36 408 A1 discloses a method for connecting a contact element with a cable. For this purpose, the insulating sheath of an electrical cable having a conductor surrounded by an insulating sheath is stripped at the end and the corresponding end of the conductor is guided into the guide bore of a socket-shaped connecting element. This is then pressed by radial deformation (rotary swaging) onto the plugged-in conductor, before the connecting element is finally welded—by means of ultrasonic welding—onto the contact element.

WO 2019/199 758 A1 also relates to pressing the sleeve of a connecting element onto the exposed end portion of the conductor of an electrical cable. For this purpose, the tool performing the said pressing has a die with a decagonal inner contour.

DE 10 2017 108 399 A1 discloses a radial press that performs radial deformation of workpieces. This has eight base jaws, which are disposed around a press axis and can be synchronously moved radially inward and outward by means of a drive unit. On these, it is possible to replaceably mount press jaws, which are provided radially inward with a pressing face specifically adapted to the respective workpiece to be pressed.

### SUMMARY

The present disclosure provides a way in which, by its application with respect to the topic explained in the introduction, namely the equipping of an electrical or electronic component element that is cylindrical at least in portions with a metal sheath surrounding it in close-fitting manner, good results in the respect shown hereinabove can be achieved with relatively low manufacturing-related expense.

The objective set in the foregoing is achieved according to the present disclosure, i.e. by a method for equipping an electrical or electronic component element that is cylindrical at least in portions with a metal sheath surrounding it in close-fitting manner, comprising the following steps:
providing the electrical or electronic component element and a sheath blank that comprises a plastically deformable metal material, is cylindrical at least in portion and for the purpose has an extra-large size;
providing an auxiliary sleeve that is slit at least in portions in axial extent, is resiliently flexible in radial direction and has an extra-large size relative to the sheath blank;
assembling the electrical or electronic component element, sheath blank and auxiliary sleeve as a group, wherein the auxiliary sleeve surrounds the sheath blank with clearance at least in portions and the latter surrounds the electrical or electronic component element with clearance at least in portions;
introducing the group into the workpiece-holding space of the pressing tool of a radial press, which has at least four press jaws that can be synchronously moved radially in the direction of a press axis by means of a drive device;
closing the pressing tool at least one time with successively occurring bearing of the press jaws on the auxiliary sleeve, elastic radial contraction of the auxiliary sleeve until it bears on the sheath blank and plastic radial contraction of the sheath blank until it bears on the electrical or electronic component element;
opening the pressing tool with successively occurring lifting of the auxiliary sleeve away from the sheath produced from the sheath blank by plastic deformation and lifting of the press jaws away from the auxiliary sleeve;
removing the component part comprising the electrical or electronic component element joined together with the metal sheath surrounding it in close-fitting manner and the auxiliary sleeve from the pressing tool, and removing the component part from the auxiliary sleeve.

For equipping an electrical or electronic component element that is cylindrical at least in portions with a metal sheath surrounding it in close-fitting manner, embodiments of the invention makes it possible to resort to established radial presses that work reliably and with the highest precision, such as manufactured and sold in the most diverse designs, namely by Uniflex-Hydraulik GmbH, 61184 Karben, Germany, and also as known from extensive patent literature (see, for example, DE 41 35 465 A1, DE 199 12 976 A1 and DE 198 17 882 B4 concerning radial presses in so-called “yoke-type press” construction, DE 101 49 924 A1 concerning radial presses in so-called “hollow piston press” construction and DE 28 44 475 A1, DE 36 11 253 A1, DE 100 47 025 C2 and DE 33 31 721 A1 concerning radial presses in other constructions). The auxiliary sleeve used in connection with embodiments of the inventive method for forming the sheath blank in order to transform it to a close-fitting sheath on the electrical or electronic component element and in the pressing process extending between the press jaws of the pressing tool of the radial press and the sheath blank, while surrounding the latter, at the same time effectively counteracts the formation of burrs or ridges, which without use of the said auxiliary sleeve would be formed by material displaced during the pressing process from the sheath blank onto its surface, between each two press jaws adjacent to one another. In this respect, it is possible, by application of embodiments of the present invention, to achieve, without post-machining of the surface of the finished electrical or electronic component part, such a good condition or quality of precisely that surface which, without the use of an auxiliary sleeve, could be achieved only via expensive post-machining.

By the fact that displacement of the material of the sheath blank into the gaps present between each two press jaws adjacent to one another is effectively prevented while it is being plastically deformed, the instant at which the sheath blank bears on the electrical or electronic component element during its deformation can be detected particularly accurately by a correspondingly sharply pronounced increase of force or pressure in the drive unit of the radial press. This permits particularly precise control of the radial press in the sense of workpiece-specific interruption or workpiece-specific termination of the closing movement. This safeguards the electrical or electronic component element from mechanical overload, which represents an inestimable manufacturing-related advantage precisely for electrical and electronic component elements having (typically brittle) ceramic structures.

As regards the deformation of a burr or ridge of displaced material of the sheath blank where the slit region of the auxiliary sleeve interacts with the surface of the sheath blank during deformation of the latter, a particularly preferred further embodiment of the inventive method characterized by several successive closing movements of the pressing tool may be applicable, wherein the pressing tool is opened at least partly between two closing processes and the sheath blank deformed in the preceding closing process or the sheath formed from the sheath blank is rotated relative to the auxiliary sleeve. In this way the burr or ridge produced in the first or preceding closing process is shifted to where it lies under the non-slit region of the auxiliary sleeve for the second or subsequent closing process, whereby the burr or ridge is leveled out once again.

In this connection, it is quite particularly advantageous when the pressing tool is partly opened in such a way between the two closing processes, i.e. precisely so far that the press jaws continue to bear on the auxiliary sleeve, although this lifts away from the sheath blank that was plastically reshaped during the preceding closing process or from the sheath formed from the sheath blank. In this way, the press jaws hold the auxiliary sleeve, whereby—without manual or other retention of the auxiliary sleeve—the intermediate product consisting of electrical or electronic component element and partly deformed sheath blank (or of the sheath formed from the sheath blank) can be rotated without problems (for example by 180°) around its axis in the auxiliary sleeve—retained by the press jaws—before the second or further process of closing of the radial press is initiated.

In the interests of particularly homogeneous pressing, as is of considerable practical importance precisely for electrical or electronic component elements containing ceramic structures, it may be particularly advantageous if a pressing tool having at least eight press jaws is used to implement the method. On the other hand, even such radial presses in which the pressing tool has only four press jaws may prove favorable for implementation of the method. The advantage of this configuration consists in the smaller number of gaps distributed over the circumference of the pressing tool and present between each two press jaws and thus-compared with a larger number of press jaws-larger total area with which the press jaws bear on the auxiliary sleeve and act on it.

As regards the auxiliary sleeve, it is particularly advantageous when it consists of spring steel. This is so because the elastically resilient flexibility of the auxiliary sleeve to the point that, after the (plastic) deformation of the sheath blank, it completely springs back again and regains its original shape during opening of the radial press, is decisive from two viewpoints. Thus the finished electrical or electronic component part can be removed from the auxiliary sleeve without problems and the latter can be kept in readiness, without post-machining, for the next use.

The inner face—maintained in contact with the sheath blank during its deformation—of the auxiliary sleeve is preferably ideally smooth and free of roughnesses for typical cases of application of the present invention. Nevertheless, raised and/or lowered areas purposely defined on it may also be created, in order in this way to impress corresponding lowered or raised areas on the surface of the sheath blank while it is being deformed in the radial press.

In the individual case, it may prove favorable during application of the method to use an auxiliary sleeve—in this case protruding from the pressing tool at one end at least—which is not slit in axial extent over its entire length, but instead in which the slit ends at one end at least of the auxiliary sleeve before the axial limit of the latter. In the vast majority of application situations, however, the use of an auxiliary sleeve slit over its entire length in axial extent proves advantageous.

As regards the execution of the slit of the auxiliary sleeve, a not inconsiderable margin for configuration exists in the context of the present invention, and in fact with regard both to the general shape and to the fine profiling—superposed on the respective general shape—of the two rims bounding the slit. Thus a first preferred further development of the present invention is characterized in that an auxiliary sleeve having a slit oriented generally parallel to its axis is used. This is a particularly simple variant in terms of manufacturing technology. In terms of manufacturing technology, what may be more demanding—from the perspective of the most homogeneous stress distribution possible within the electrical or electronic component part to be manufactured—but nevertheless associated with advantages as regards the function, is the use of auxiliary sleeves with a slit extending in coiled manner, i.e. generally along a helical line. The pitch of this helical line is advantageously chosen such that the slit executes at least one full revolution (360°), particularly preferably at least two full evolutions (720°), on the surface of the auxiliary sleeve.

As regards the configuration of the rims of the auxiliary sleeve that bound the slit and are superposed on the general shape of the slit (see above), not only unprofiled edges but also several variations with profiled edges are conceivable and usable with advantage. In particular, within the scope of a preferred further development of the present invention, auxiliary sleeves may be used in which the rims bounding the slit have undulating construction in a manner conforming to one another. According to another, particularly preferred configuration, auxiliary sleeves may be used in which interlocking finger-shaped profilings with fingers that alternately overlap one another are constructed on both rims bounding the slit; in this way the possibility offered by the “slit” of radial contraction of the auxiliary sleeve is subdivided over a multiplicity of slit portions offset from one another in circumferential direction. In the case of construction of the auxiliary sleeve with a coiled slit extending generally along a helical line (see above), a stepped construction of the two rims bounding the slit, with steps that overlap one another, may be very advantageous, depending on the pitch of the helical line. Here also, just as in the case of the variants described in the foregoing that have interlocking finger-shaped profilings, the possibility offered by the “slit” of radial contraction of the auxiliary sleeve is subdivided over a multiplicity of slit portions offset from one another in circumferential direction. For most common applications, auxiliary sleeves having a coiled slit extending generally along a helical line are likewise usable with very good results, wherein the rims bounding the slit are coiled parallel to one another in a manner that defines a helical gap. This embodiment is characterized by particularly simple manufacturability—by wrapping with a metal strip (skelp) consisting, for example, of spring steel.

According to yet another preferred configuration, the rims of the auxiliary sleeve bounding the slit may be beveled in such a way that they overlap or cover one another in circumferential direction. This is the case in particular for auxiliary sleeves having a slit oriented generally parallel to the axis of the auxiliary sleeve. This also is a feature suitable for contributing to a reduced danger of formation of burrs or ridges in the region of the slit of the auxiliary sleeve. By way of precaution, it is pointed out that the foregoing explanations regarding the geometric and structural design of the auxiliary sleeve refer to its stress-free condition, i.e. that established in the absence of external forces (except gravity).

### BRIEF DESCRIPTION OF THE DRAWING

The present invention will be explained in more detail hereinafter on the basis of several preferred exemplary embodiments illustrated in the drawing, wherein

FIG. 1 shows an electrical component part to be manufactured by application of the inventive method,

FIG. 2 shows, in an axial section, a radial press that can be used for manufacture of the component part according to FIG. 1,

FIG. 3 shows, in a cross section normal to the axis, the relevant region of the radial press according to FIG. 2 during manufacture of the component part according to FIG. 1 in a first process stage,

FIG. 4 shows a cross section corresponding to FIG. 3 in a second process stage of the manufacture of the component part according to FIG. 1,

FIG. 5 shows a first preferred embodiment of an auxiliary sleeve that can be used for the manufacture of the component part according to FIG. 1 using the radial press according to FIG. 2,

FIG. 6 shows a second preferred embodiment of an auxiliary sleeve that can be used for the manufacture of the component part according to FIG. 1 using the radial press according to FIG. 2,

FIG. 7 shows a third preferred embodiment of an auxiliary sleeve that can be used for the manufacture of the component part according to FIG. 1 using the radial press according to FIG. 2, and

FIG. 8 shows a fourth preferred embodiment of an auxiliary sleeve that can be used for the manufacture of the component part according to FIG. 1 using the radial press according to FIG. 2.

### DETAILED DESCRIPTION OF THE PREFERRED EMBODIMENTS

Electrical component part 1 illustrated in FIG. 1 in the form of a temperature sensor 2 comprises, in a way known as such, an electrical component element 5 of cylindrical geometry, designed as sensor element 3 and provided with terminal wires 4. This is equipped with a sheath 6, in the sense that it is surrounded in close-fitting manner by a metal sheath 6. For subsequent positionally correct placement of temperature sensor 2 in a bore provided in a device part, sheath 6 has a collar 7.

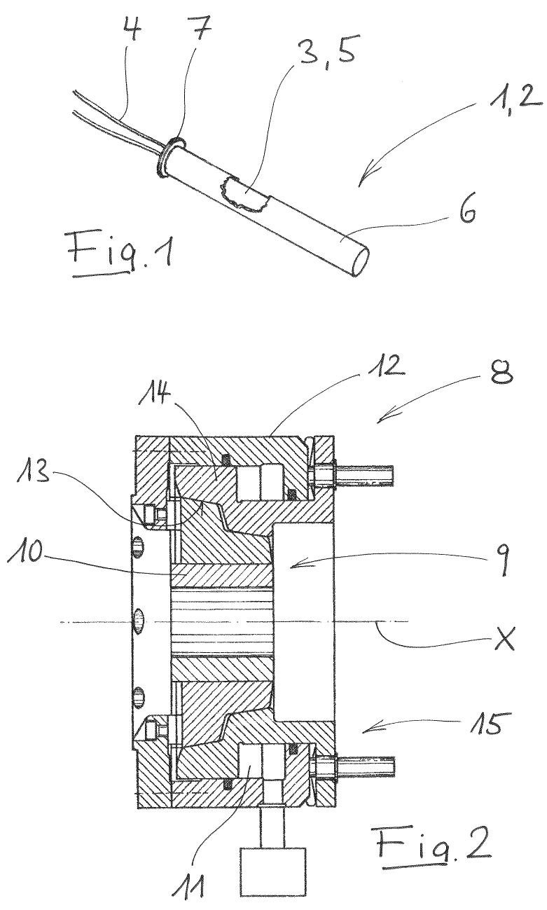

For the manufacture of temperature sensor 2, a commercial radial press is used, such as illustrated—in axial section—by way of example in FIG. 2. The radial press illustrated in FIG. 2 and known as such is extensively described and explained in DE 28 44 475 A1. For this reason, and also especially because structural details of the radial press are not material to the present invention, a detailed description will not be provided. To the contrary, what is sufficient for understanding the present embodiment of the invention is the knowledge that radial press 8 has a pressing tool 9 with eight press jaws 10, which can be synchronously moved radially in the direction of press axis X by means of a drive unit 15—that in this case is hydraulic and comprises an annular piston 14 that can be urged via an annular hydraulic working chamber 11, can be displaced in housing 12 along press axis X and has control faces 13 inclined relative to press axis X. It is emphasized once again that FIG. 2 shows, by way of example, merely one possible construction of the radial press. For implementation of the present invention, all known and commercially available radial presses are suitable, especially all radial presses of Uniflex-Hydraulik GmbH, 61184 Karben, Germany.

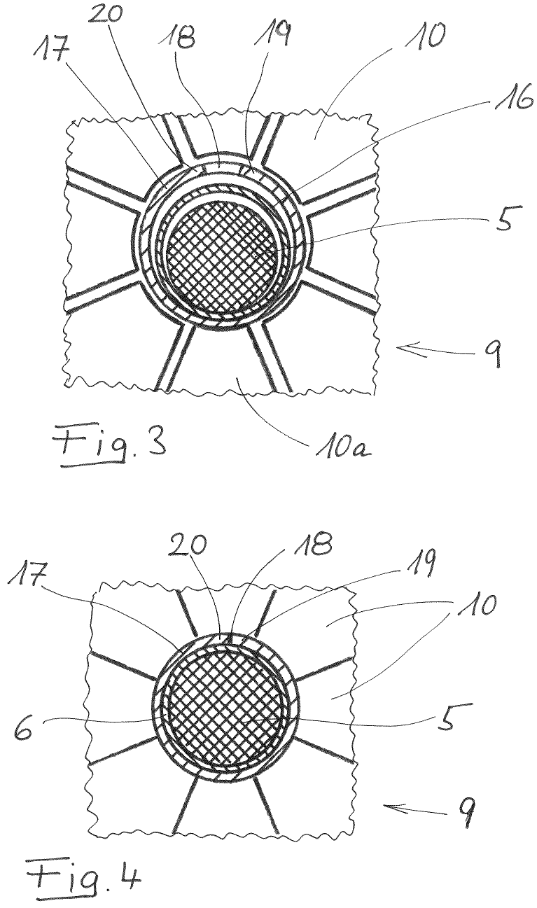

FIG. 3 shows (schematically and therefore not necessarily to scale) the situation prior to the beginning of the deformation executed in radial press 8. And, in fact, electrical component element 5 is received in a cylindrical sheath blank 16, which surrounds it except for collar 7. In this situation, clearance is present between electrical component element 5 and sheath blank 16; in other words, sheath blank 16 has an extra-large size compared with electrical component element 5, and so the latter is introduced loosely into sheath blank 16. This sheath blank 16 consists of a plastically deformable metal material.

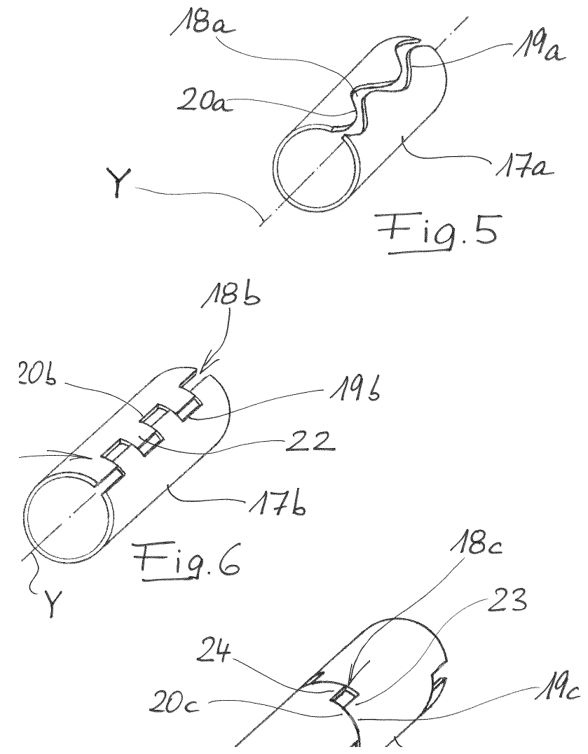

For its part, sheath blank 16 is received in an auxiliary sleeve 17 that surrounds it and consists of spring steel. This auxiliary sleeve 17 (see FIGS. 5-7)—slit in axial extent and flexible in elastically resilient manner in radial direction—has an existing extra-large size compared with sheath blank 16; thus it surrounds sheath blank 16 loosely, i.e. with clearance.

The entire assembly (group) comprising auxiliary sleeve 17, sheath blank 16 and electrical component element 5 is introduced into the workpiece receiving space of pressing tool 9 of radial press 8; thus it is surrounded by the eight press jaws 10. What is shown is the situation in which the said group comprising auxiliary sleeve 17, sheath blank 16 and electrical component element 5 is placed on lower press jaw 10a.

FIG. 4 shows the situation at the end of the process of closing of pressing tool 9. During the closing of pressing tool 9 and thus synchronous radial movement of press jaws 10 radially inward in the direction of press axis X, beginning with the initial situation shown in FIG. 3, what takes place successively is bearing of press jaws 10 on auxiliary sleeve 17, a first elastic radial contraction of auxiliary sleeve 17 until it bears on sheath blank 16 and a continued elastic radial contraction of auxiliary sleeve 17 with simultaneous plastic radial contraction of sheath blank 16 until it bears—as sheath 6—on electrical component element 5 (see FIG. 4).

During the subsequent opening of pressing tool 9, auxiliary sleeve 17—narrowed in elastically resilient manner—lifts away from sheath 6 produced by plastic deformation from sheath blank 16. After auxiliary sleeve 17 has regained its original geometry by resiliently expanding once again, press jaws 10 lift away from auxiliary sleeve 17 by continued opening of pressing tool 9. In this way, electrical component part 1—consisting of electrical component element 5 equipped with close-fitting sheath 6—and auxiliary sleeve 17 are removed (simultaneously or successively) from pressing tool 9. If electrical component part 1 and auxiliary sleeve 17 are removed simultaneously from opened pressing tool 9, electrical component part 1 is then removed separately from auxiliary sleeve 17.

FIGS. 5-8 show four preferred configurations of an elastically resilient auxiliary sleeve 17 consisting of spring steel. All four auxiliary sleeve configurations are respectively slit over their entire length in axial extent; the respective slit 18 thus extends from one axial limit of auxiliary sleeve 17 to the other.

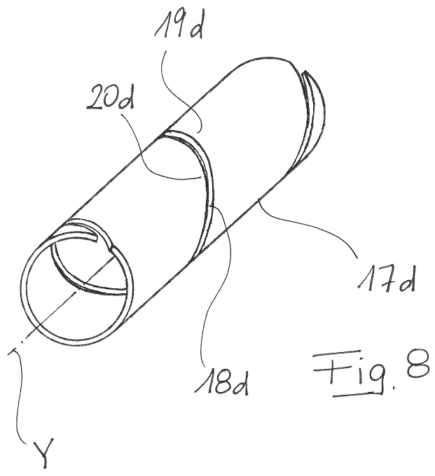

In the two configurations according to FIGS. 5 and 6, the respective slit 18a, 18b is oriented generally parallel to axis Y of auxiliary sleeve 17a, 17b. In contrast, auxiliary sleeves 17c and 17d according to FIGS. 7 and 8 have a generally coiled slit 18c and 18d respectively, i.e. slit 18c, 18d extends generally along a helical line.

Incidentally, FIGS. 5-7 illustrate three profilings, superposed on the general shape of slit 18, of rims 19, 20 of the respective auxiliary sleeve 17 bounding the respective slit 18. According to FIG. 5, the two rims 19a, 20a of auxiliary sleeve 17a bounding the slit have undulating construction in a manner conforming to one another. In the configuration shown in FIG. 6, interlocking finger-shaped profilings 21 with fingers 22 alternately overlapping one another are constructed on both rims 19b, 20b of auxiliary sleeve 17b bounding slit 18b. And in auxiliary sleeve 17c according to FIG. 7, the two rims 19c, 20c bounding slit 18c are stepped, with steps 23, 24 overlapping one another.

In contrast, in auxiliary slit 17d according to FIG. 8, rims 19d, 20d bounding slit 18b are not profiled. Thus rims 19d, 20d bounding slit 18d are helically coiled in a manner parallel to one another; they bound a continuous gap of helical shape and defined width.

All slit variants are analogous in the sense that they permit defined radial contraction of the respective auxiliary sleeve 17a, 17b, 17c and 17d.

What is claimed is:

1. A method for equipping an electrical or electronic component element (5) that is cylindrical at least in portions with a metal sheath (7) surrounding it in close-fitting manner, with the following steps:
providing the electrical or electronic component element (5) and a sheath blank (16) that comprises a plastically deformable metal material, is cylindrical at least in portions and for the purpose has an extra-large size;
providing an auxiliary sleeve (17) that is slit at least in portions in axial extent, is resiliently flexible in radial direction and has an extra-large size relative to the sheath blank (16);
assembling the electrical or electronic component element (5), sheath blank (16) and auxiliary sleeve (17) as a group, wherein the auxiliary sleeve (17) surrounds the sheath blank (16) with clearance at least in portions and the latter surrounds the electrical or electronic component element (5) with clearance at least in portions;
introducing the group into the workpiece-holding space of the pressing tool (9) of a radial press (8), which has at least four press jaws (10) that can be synchronously moved radially in the direction of a press axis (X) by means of a drive device (15);
closing the pressing tool (9) at least one time with successively occurring bearing of the press jaws (10) on the auxiliary sleeve (17), elastic radial contraction of the auxiliary sleeve (17) until it bears on the sheath blank (16) and plastic radial contraction of the sheath blank (16) until it bears on the electrical or electronic component element (5);
opening the pressing tool (9) with successively occurring lifting of the auxiliary sleeve (17) away from the sheath (6) produced from the sheath blank (16) by plastic deformation and lifting of the press jaws (10) away from the auxiliary sleeve (17);
removing the component part (1) comprising the electrical or electronic component element (5) joined together with the metal sheath (6) surrounding it in close-fitting manner and the auxiliary sleeve (17) from the pressing tool (9), and removing the component part (1) from the auxiliary sleeve (17).

2. The method of claim 1 comprising several successive closing movements of the pressing tool (9), wherein the pressing tool (9) is opened at least partly between two closing processes and the sheath blank (16) deformed in the preceding closing process or the sheath (6) formed from the sheath blank (16) is rotated relative to the auxiliary sleeve (17).

3. The method of claim 2, wherein the pressing tool (9) is partly opened in such a way between two closing processes that the press jaws (10) continue to bear on the auxiliary sleeve (17), although this lifts away from the sheath blank (16) that was plastically deformed during the preceding closing process or from the sheath (6) formed from the sheath blank (16).

4. The method of claim 1, wherein a pressing tool (9) having at least eight press jaws (10) is used.

5. The method of claim 1, wherein an auxiliary sleeve (17) consisting of spring steel is used.

6. The method of claim 1, wherein an auxiliary sleeve (17) slit over its entire length in axial extent is used.

7. The method of claim 1, wherein an auxiliary sleeve (17a, 17b) having a slit (18a, 18b) oriented generally parallel to the axis (Y) of the auxiliary sleeve (17a, 17b) is used.

8. The method of claim 1, wherein an auxiliary sleeve (17c, 17d) having a slit (18c, 18d) extending generally along a helical line is used.

9. The method of claim 1, wherein an auxiliary sleeve (17a) is used in which the rims (19a, 20a) bounding the slit (18a) have undulating construction in a manner conforming to one another.

10. The method of claim 1, wherein an auxiliary sleeve (17b) is used in which interlocking finger-shaped profilings (21) with fingers (22) alternately overlapping one another are constructed on both rims (19b, 20b) bounding the slit (18b).

11. The method of claim 8, wherein an auxiliary sleeve (17c) is used in which the rims (19c, 20c) bounding slit (18c) are constructed in stepped manner, with steps (23, 24) overlapping one another.

12. The method of claim 8, wherein an auxiliary sleeve (17d) is used in which the rims (19d, 20d) bounding the slit (18d) are helically coiled in a manner parallel to one another and bounding a gap.
